(19) United States
(12) Patent Application Publication
(10) Pub. No.: US 2008/0315111 A1
(43) Pub. Date: Dec. 25, 2008

(54) PARTICLE THERAPY SYSTEM

(76) Inventor: Andres Sommer, Langensendelbach (DE)

Correspondence Address: BRINKS HOFER GILSON & LIONE, P.O. BOX 10395, CHICAGO, IL, 60610, US

(21) Appl. No.: 12/142,412

(22) Filed: Jun. 19, 2008

(30) Foreign Application Priority Data
Jun. 25, 2007 (DE) 10 2007 029 192.4

(51) Int. Cl. H01J 3/14

(52) U.S. Cl. 250/396 R

(57) ABSTRACT

A particle therapy system is provided. The particle therapy system includes a rotatable gantry with a gantry wall that surrounds an interior. A small irradiation chamber, with an irradiation chamber wall, is located inside the interior. The irradiation chamber wall is spaced apart from the gantry wall, and a deflection chamber is embodied between the two walls. The irradiation chamber wall includes a plurality of wall elements, which to enlarge the irradiation chamber are adjustable in the direction of the deflection chamber, for example, when positioning a treatment table in the small irradiation chamber, such that an opening in the irradiation chamber wall is created.

The present patent document claims the benefit of the filing date of DE 10 2007 029 192.4, filed Jun. 25, 2007, which is hereby incorporated by reference.

### BACKGROUND

The present embodiments relate to a particle therapy system.

In a particle therapy system, especially for cancer, a particle beam, for example, including protons or heavy ions, is generated in a suitable accelerator. The particle beam is guided in a beam channel and emerges via an exit window from the beam channel into an irradiation chamber. An irradiation unit may be disposed at the end of the beam channel. The irradiation unit (e.g., a nozzle) includes at least one beam detector and passive beam elements. The irradiation unit may be located directly before the exit window. For the most precise possible treatment, the patient's tissue, which is to be irradiated, is positioned in the isocenter (the point struck by the beam upon rotation of the gantry) of the system.

Typically, only one stationary beam exit window is provided because of the complicated beam course. In some systems, however, the gantry is rotatable. Because of the complicated beam course, the gantry has a very large volume. So that the treatment table with the patient lying on it can be positioned in a usually cylindrical interior surrounded by the gantry, this chamber has a very large diameter, such as 5 meters. To enable rotating the gantry, with the nozzle protruding into the interior, by 360°, often no floor is provided below the treatment table. Instead, a fixed floor is disposed only outside the cylindrical chamber. Because of the lack of a floor and because of the large diameter, the patient, in the therapy position, floats about 3.5 meters above a floor region of the cylindrical gantry wall.

Alternatively, the interior may have a movable floor, EP 1 402 923 A1 discloses a cylindrical gantry, which surrounds an irradiation chamber. The wall of the irradiation chamber is movable and includes a plurality of segments joined flexibly to one another. The wall is curved in an upper region of the irradiation chamber and extends horizontally in a lower region of the irradiation chamber, in order to form a floor. Upon rotation of an irradiation unit about the axis of rotation of the gantry, the entire wall is rotated along with it.

### SUMMARY

The present embodiments may obviate one or more of the drawbacks or limitations inherent in the related art. For example, one embodiment may include a particle therapy system that provides safety during the irradiation of a patient and unrestricted mobility of the gantry components.

In one embodiment, a particle therapy system includes a rotatable gantry, an irradiation chamber, and a deflection chamber. The rotatable gantry includes a gantry wall that surrounds an interior. The irradiation chamber includes an irradiation chamber wall. The irradiation chamber is located inside the interior. The irradiation chamber wall is spaced apart from the gantry wall. The deflection chamber is embodied (disposed) between the two walls, and the irradiation chamber wall includes a plurality of wall elements. The plurality of wall elements are adjustable in the direction of the deflection chamber such that an opening in the irradiation chamber wall is created. The plurality of wall elements are adjustable to enlarge the irradiation chamber.

The irradiation chamber may be small, so that the treatment table does not float several meters above the floor region of the gantry. The small irradiation chamber may increase the safety of the patient when irradiating and improve a sense of comfort to the patient. A small irradiation chamber may minimize the risk of injury if the patient should happen to fall from the treatment table. In addition, the patient may be easily rescued in an emergency, for example, if there is a power failure. Individual wall elements or groups of wall elements may be moved away, in order to form an opening. The opening may enable free positioning of the treatment table relative to an irradiation unit of the gantry and free movement of the irradiation unit. The opening may provide a radial enlargement of the irradiation chamber, so that, for example, the treatment table is optimally positioned without causing a collision with the irradiation chamber wall. The treatment table may protrude partway out of the irradiation chamber in the direction of the gantry wall through the opening.

The system may include the outer gantry wall, which surrounds the interior, and the irradiation chamber with the irradiation chamber wall, which is disposed inside the interior. The gantry wall, which may be cylindrical, may bear (support) the load of the rotatable irradiation unit. The irradiation unit may extend past the deflection chamber into the irradiation chamber. The irradiation chamber wall may include an opening for an exit window of the irradiation unit. The irradiation chamber is designed in particular such that regardless of its shape, its axis of symmetry coincides with an axis of rotation of the gantry. The irradiation chamber may be a chamber that is closed on all sides, except for a front side for moving the treatment table inside. Alternatively, the chamber may be open from at least one further side, such as from above, so that a ceiling region of the irradiation chamber is formed by the gantry wall. The irradiation chamber may be disposed in the interior, such that the deflection chamber encircles the irradiation chamber completely, and thus, the irradiation chamber, viewed in cross section, is not in direct contact with the gantry wall at any point. Since each of the wall elements extends in particular along the entire axial length of the irradiation chamber, the opening in the irradiation chamber wall, when a wall element is being moved away, likewise may extend along the entire axial length of the irradiation chamber. Alternatively, depending on the axial length of the wall elements, the opening may instead extend only partway in the axial direction.

The cross-sectional area of the irradiation chamber may be approximately 20% to 60% smaller than the cross-sectional area of the interior The irradiation chamber wall may be spaced apart from the gantry wall by approximately 0.5 m. The volume of such a small irradiation chamber may be reduced to a minimum, so as to enable unhindered positioning of the treatment table and/or to enable the simultaneous presence of medical staff in the irradiation chamber.

In one embodiment, at least the wall elements of a floor region of the irradiation chamber wall may be load-bearing. The wall elements of the irradiation chamber wall may be load-bearing. The floor may be walked on and provide high patient safety and at the same time enable access to the patient.

In one embodiment, the floor region of the irradiation chamber wall is embodied at the level of a fixed floor adjoining the irradiation chamber. This makes it substantially easier for the patient and the staff to enter or leave the irradiation chamber, since the floor region is in particular flush with the fixed floor.

In one embodiment, the wall elements of the irradiation chamber wall may be secured to a back wall. Securing the wall elements to a back wall may allow a stable construction of the irradiation chamber, since the back wall forms a solid, load-bearing foundation on which the wall elements are suitably supported. The back wall may be a part of the gantry wall and rotates with the gantry. The irradiation chamber wall and the back wall may rotate in common, yet a floor is always present.

In one embodiment, the wall elements may be pivotably supported. The wall elements may be disposed on the back wall, for example, or on one another at one or more points by joints or hinge connections. A pivotable support may swing the wall elements open until they strike the back wall or the adjacent wall element, so as to create enough space for the opening in the radial direction.

In an alternative embodiment, the wall elements may be movable one after the other in the circumferential direction. The wall elements may be supported on the back wall. Alternatively, the irradiation chamber may have a framework or scaffold that defines the contours of the irradiation chamber and on which the wall elements are adjustably supported.

In one embodiment, the irradiation chamber may be cylinder. The shape of the irradiation chamber may be adapted to the shape of the gantry wall, and a concentric disposition of the irradiation chamber relative to the interior, which is especially advantageous for the operation of the irradiation unit.

In an alternative embodiment, the irradiation chamber may be a parallelepiped. During treatments, the wall elements forming the floor region remain unmoved out of the most commonly used incident radiation positions of the irradiation unit, that is, 0° (vertically from above) and ±90°, so that there is always a floor in the irradiation chamber. The floor region may be flat and horizontal, so that is more convenient to walk on than the curved floor of a cylindrical irradiation chamber.

The wall elements may be automatically movable. A drive mechanism may automatically move the wall elements. The drive mechanism may be a motor drive mechanism, a hydraulic drive, or pneumatic drive. The particle therapy system may have a high degree of automation. The automation may lead to simple and precise operation.

The system may include a control unit. The control unit may automatically move the individual wall elements as a function of the position of a treatment table and/or of an irradiation unit. The movement of the wall elements may be synchronized with the movement of the treatment table and of the irradiation unit. The synchronized movement may provide precision in adjusting the positions. For example, if a collision of the treatment table with the irradiation chamber wall threatens to occur, one or more wall elements may be moved away, so as to enable unrestricted movement of the treatment table with the aid of the opening formed in the irradiation chamber wall.

### BRIEF DESCRIPTION OF THE DRAWINGS

FIG. 1 illustrates one embodiment of a particle therapy system with a cylindrical irradiation chamber;

FIG. 2 illustrates another embodiment of a particle therapy system with a cylindrical irradiation chamber;

FIG. 3 illustrates one embodiment of a particle therapy system with a parallelepiped-shaped irradiation chamber; and

FIG. 4 illustrates another view of the irradiation chamber of FIG. 3.

### DETAILED DESCRIPTION

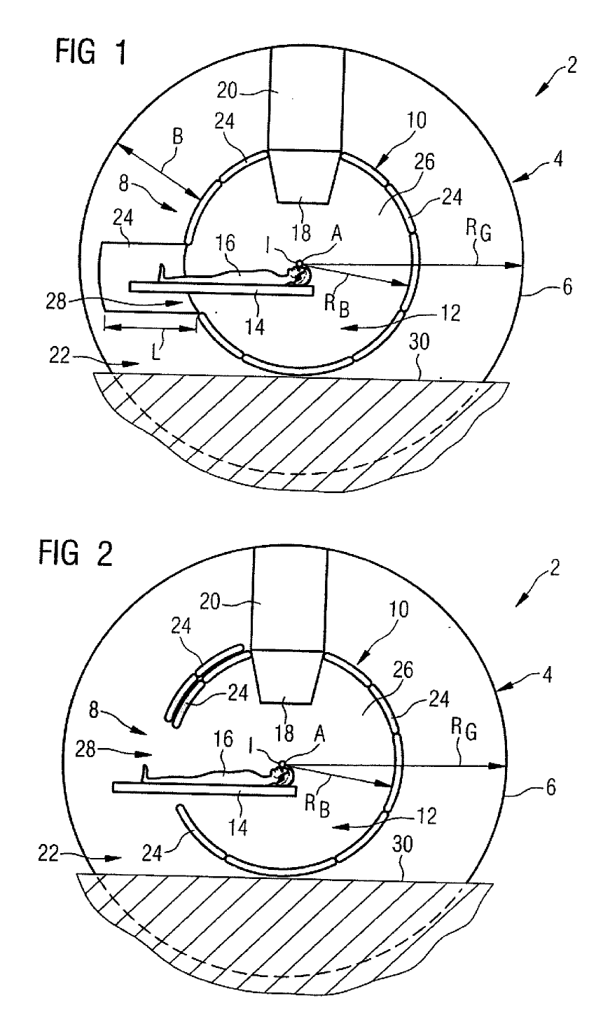

FIG. 1 shows a particle therapy system 2. The system 2 includes a gantry 4 that is rotatable about an axially extending axis of rotation A (indicated here by a point). As shown in FIG. 1, the point A coincides with an isocenter I of the gantry 4. The gantry 4 has a gantry wall 6, which surrounds a cylindrical interior 8. Inside the interior 8, an irradiation chamber wall 10, which may be a cylindrical casing, is disposed concentrically to the gantry wall 6. The irradiation chamber wall 10 may encase a cylindrical irradiation chamber 12. In a beam channel of the gantry 4, a particle beam, such as a heavy-ion or proton beam, is generated for treating a patient 16 who is lying on a treatment table 14. The particle beam emerges into the irradiation chamber 12 via an exit window 18 of an irradiation unit 20.

The irradiation chamber wall 10 is spaced apart from the gantry wall 6, so that no direct contact takes place between the irradiation chamber wall 10 and the gantry 6. A deflection chamber 22 is formed between the two walls 6, 10.

As shown in the example of FIG. 1, the radius R_{B} of the irradiation chamber 12 is approximately 7/10 of the radius R_{G} of the gantry 4, so that the cross-sectional area of the irradiation chamber 12 is smaller, by approximately 50%, than the cross-sectional area of the interior 8. The irradiation chamber 12, which is markedly smaller than the interior 8 of the gantry 4, may be safer if the patient 16 falls from the treatment table 16, or if the patient has to be rescued.

As shown in the example of FIG. 1, the irradiation chamber wall 10 may include a plurality of curved wall elements 24, which are supported on a rotatable back wall 26. The back wall 26, in this exemplary embodiment, may be a part of the gantry 4. The back wall 26 may be a load-bearing wall that demarcates the irradiation chamber 12 from behind. Upon a rotation of the gantry 4, for positioning the irradiation unit 20, both the back wall 26 and the wall elements 24 of the irradiation chamber wall 10 that are supported on it also rotate. The danger of a collision of the irradiation unit 20 with one of the wall elements 24 may be averted.

As shown in the example of FIG. 1, the wall elements 24 are supported pivotably on the back wall by hinges. The wall elements 24 may be swung open until they strike the back wall 26. The dimensions of the wall elements 24 and the deflection chamber 22 may be adapted to one another, so that the wall elements 24 can be swung open until they strike the back wall 26. For example, a width B of the deflection chamber 22 in the radial direction may be greater than or equal to a length L of the wall elements 24 in the axial direction. In an alternative version, the length L of the wall elements 24 may be less than the width B of the deflection chamber 22, so that the wall elements 24 are swung open at an acute angle relative to the back wall 26. One or more of the wall elements 24 may be removed completely from the irradiation chamber wall 10.

An opening 28 in the irradiation chamber wall 10 may be created when one or more wall elements 24 are swung open or removed. The opening may enlarge the irradiation chamber 12 in the radial direction. Because of the enlargement of the irradiation chamber 12, unrestricted positioning of the treatment table 14 in the irradiation chamber 12 is made possible.

As shown in FIG. 4, a control unit 31 is operable to move the wall elements 24 in a way that is coordinated with the motion of the treatment table 14 and/or of the irradiation unit 20. Depending on the position of the irradiation unit 20 or of the treatment table 14, the control unit automatically triggers a drive mechanism of the wall elements 24, in order to make the opening 28 at the required place in the irradiation chamber wall 10.

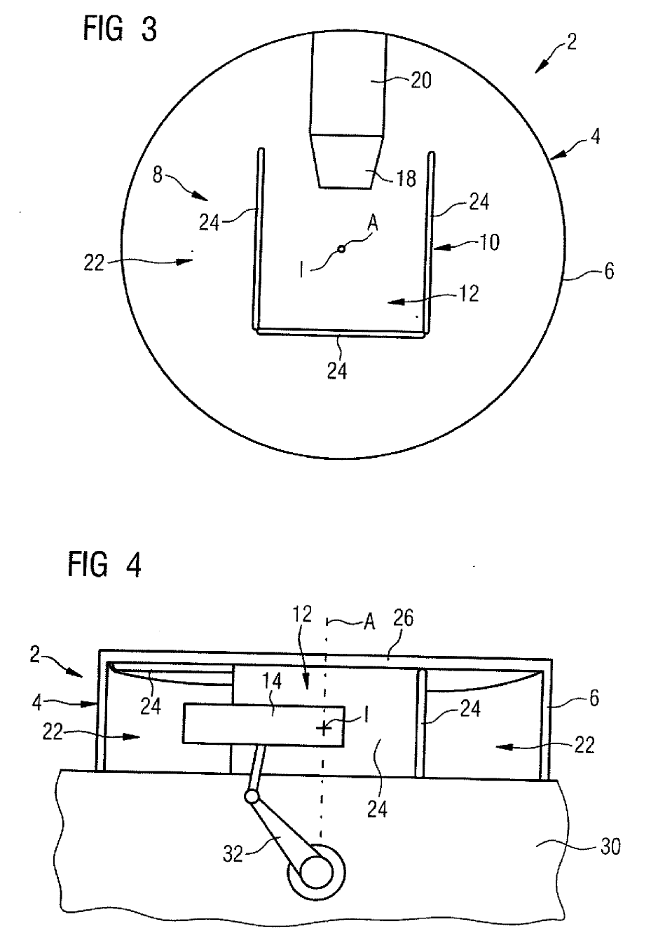

The wall elements 24 may form a floor region 25 (see FIGS. 3 and 4) of the irradiation chamber 12. The wall elements 24 may be disposed approximately at the level of a fixed floor 30 that adjoins the irradiation chamber 12. Disposing the wall elements 24 at approximately the level of the fixed floor 30 may make access to the irradiation chamber 12 easier. The wall elements 24 in the floor region 25 may be load-bearing, so that they can be walked on. However, all the wall elements 24 may be load-bearing, so that upon the rotation of the gantry 4 and the irradiation chamber wall 10, a floor that can be walked on is always present.

For performing the therapy, the patient 16 is first immobilized on the treatment table 14. The treatment table 14 is moved via a robot arm 32 (see FIG. 4) into the irradiation chamber 12 and oriented such that a diseased tissue of the patient 16 is located at the isocenter I of the gantry 4. For setting a favorable angle for the irradiation, the gantry 4 may be rotated about its axis of rotation A, whereupon both the back wall 26 and the irradiation chamber wall 10 rotate with the gantry 4.

The exemplary embodiment of FIG. 2 differs from the exemplary embodiment shown in FIG. 1 in that the wall elements 24 are not supported pivotably, but may be moved one after the other to form the opening 28. One or more suitable guides, such as linear guides, may be mounted on the back wall 25 and are provided for a sliding motion of the individual wall elements 24 in the circumferential direction of the irradiation chamber 12.

FIG. 3 shows an alternative embodiment of the particle therapy system 2. The irradiation chamber 12 may be parallelepiped. However, the irradiation chamber 12 may have other geometrical shapes instead, such as a hexagonal cross section. The irradiation chamber 12 may include three flat wall elements 24: two located laterally and a further one that forms the floor region 25 of the irradiation chamber 12. The irradiation chamber 12 is open at the top, to facilitate the insertion of the exit window 18 and a slight deflection of the irradiation unit 20 from its vertical position shown.

Upon a rotation of the irradiation unit 20 of the gantry 4 by a greater angle, and for unhindered positioning of the treatment table 14, the wall elements 24 may be swung open, as shown in FIG. 4. The wall elements 24 may be supported pivotably on the back wall 26. The floor wall element 24 may be located at the same level as the fixed floor 30 and is flush with the fixed floor 30.

As can be seen from FIG. 4, the treatment table 14 may be positioned in the irradiation chamber 12 by a patient handling system, which in this exemplary embodiment is a robot arm 32 triggered by the above described control unit 31. The robot arm 32 is mounted on the fixed floor 30, outside the irradiation chamber 12. The robot arm 32 is a multi-axial industrial robot arm with a multiple-part mechanism. The treatment table 14 is moved translationally and rotationally using the robot arm 32, so as to position a diseased tissue of the patient 16 in the isocenter I of the gantry 4. To make optimal positioning possible, one or more of the wall elements 24 are swung open as needed, as shown in FIG. 4. During the irradiation of the patient 16, the treatment table 14 remains in a virtually horizontal position, so that the patient 16 lies stably on the table 14.

Various embodiments described herein can be used alone or in combination with one another. The foregoing detailed description has described only a few of the many possible implementations of the present invention. For this reason, this detailed description is intended by way of illustration, and not by way of limitation. It is only the following claims, including all equivalents that are intended to define the scope of this invention.

1. A particle therapy system comprising:
a rotatable gantry with a gantry wall that surrounds an interior, and
an irradiation chamber with an irradiation chamber wall, the irradiation chamber being located inside the interior, and
a deflection chamber disposed in a space between the irradiation chamber wall and the gantry wall,
wherein the irradiation chamber wall includes a plurality of wall elements that are adjustable in the direction of the deflection chamber such that an opening in the irradiation chamber wall is created.

2. The particle therapy system as defined by claim 1, wherein a cross-sectional area of the irradiation chamber is approximately 20% to 60% smaller than the cross-sectional area of the interior.

3. The particle therapy system as defined by claim 1, the irradiation chamber wall includes a floor region that is load-bearing.

4. The particle therapy system as defined by claim 3, wherein the floor region of the irradiation chamber wall is at a level of a fixed floor adjoining the irradiation chamber.

5. The particle therapy system as defined by claim 1, wherein the wall elements are secured to a back wall.

6. The particle therapy system as defined by claim 1, wherein the wall elements are supported pivotably.

7. The particle therapy system as defined by claim 1, wherein the wall elements are movable one after the other in a circumferential direction of the irradiation chamber.

8. The particle therapy system as defined by claim 1, wherein the irradiation chamber is a cylinder.

9. The particle therapy system as defined by claim 1, wherein the irradiation chamber is parallelepiped.

10. The particle therapy system as defined by claim 1, wherein the wall elements are automatically movable.

11. The particle therapy system as defined by claim 1, further comprising a control unit that is operable to automatically move the individual wall elements as a function of the position of a treatment table and/or of an irradiation unit.

12. The particle therapy system as defined by claim 2, the irradiation chamber wall includes a floor region that is load-bearing.

13. The particle therapy system as defined by claim 12, wherein the floor region of the irradiation chamber wall is at a level of a fixed floor adjoining the irradiation chamber.

14. The particle therapy system as defined by claim 6, wherein the wall elements are supported pivotably with hinges.

15. The particle therapy system as defined by claim 14, wherein the hinges are operable to swing the wall elements open until they strike the back wall 26.

16. The particle therapy system as defined by claim 3, wherein the floor region includes the wall elements.

17. The particle therapy system as defined in claim 1, wherein the wall elements may be removed.

18. The particle therapy system as defined in claim 11, wherein the control unit is operable to synchronize a movement of the wall elements and a movement of the treatment table and of the irradiation unit.

19. The particle therapy system as defined in claim 3, wherein the back wall may be a part of the gantry wall and is operable to rotate with the gantry.

20. The particle therapy system as defined in claim 19, wherein irradiation chamber wall and the back wall may rotate in common, yet the floor region remains in a defined position.
